(19) United States
(12) Patent Application Publication
(10) Pub. No.: US 2024/0281031 A1
(43) Pub. Date: Aug. 22, 2024

(54) PORT REPLICATOR

(71) Applicant: Panasonic Intellectual Property Management Co., Ltd., Osaka (JP)

(72) Inventor: Taketo KAWAUCHI, Osaka (JP)

(73) Assignee: Panasonic Intellectual Property Management Co., Ltd., Osaka (JP)

(21) Appl. No.: 18/653,601

(22) Filed: May 2, 2024

Related U.S. Application Data
(63) Continuation of application No. PCT/JP2022/038879, filed on Oct. 19, 2022.

(30) Foreign Application Priority Data
Nov. 12, 2021 (JP) 2021-185121

(51) Int. Cl. G06F 1/16

(52) U.S. Cl. CPC G06F 1/1632

(57) ABSTRACT

A port replicator of the present disclosure is a port replicator on which an electronic device is placed, the port replicator including a body on which the electronic device is placed, and a fixing component including a base disposed in the body and a side wall extending from the base in a direction intersecting the body and supporting an outer surface of the electronic device. The fixing component is configured to change a position of the side wall by being disposed with an orientation of the base changed.

### BACKGROUND

### 1. Technical Field

The present disclosure relates to a port replicator.

### 2. Description of the Related Art

Patent Literature (PTL) 1 discloses a function expansion device that is connected to a portable computer and expands a function of the portable computer.

PTL 1 is Unexamined Japanese Patent Publication No. 2003-67085.

### SUMMARY

The function expansion device described in PTL 1 still has room for improvement in terms of improvement in durability in a case where a plurality of computers having different external sizes are attached.

According to the present disclosure, there is provided a port replicator with improved durability in a case where a plurality of computers having different external sizes are attached.

A port replicator according to one aspect of the present disclosure is a port replicator on which an electronic device is placed, the port replicator including: a body on which the electronic device is placed; and a fixing component including a base disposed in the body and a side wall extending from the base in a direction intersecting the body and supporting an outer surface of the electronic device. The fixing component is configured to change a position of the side wall by being disposed with an orientation of the base changed.

According to the present disclosure, it is possible to provide a port replicator with improved durability in a case where a plurality of computers having different external sizes are attached.

### BRIEF DESCRIPTION OF THE DRAWINGS

FIG. 1 is a perspective view illustrating a port replicator according to a first exemplary embodiment of the present disclosure.

FIG. 2 is a perspective view illustrating an example in which an electronic device is placed on the port replicator of FIG. 1.

FIG. 3 is a perspective view illustrating an example in which another electronic device is placed on the port replicator of FIG. 1.

FIG. 4 is a side view of the port replicator of FIG. 1.

FIG. 5 is an exploded view of the port replicator of FIG. 1.

FIG. 6A is a perspective view illustrating fixing components.

FIG. 6B is a perspective view illustrating the fixing components.

FIG. 7A is a top view of the port replicator of FIG. 1.

FIG. 7B is a top view of the port replicator in a state where the disposition of fixing components is changed.

FIG. 8 is a perspective view of a port replicator according to a second exemplary embodiment of the present disclosure.

FIG. 9 is a perspective view of the port replicator of FIG. 8.

FIG. 10A is a perspective view illustrating fixing components.

FIG. 10B a perspective view illustrating the fixing components.

FIG. 11A is a top view of the port replicator of FIG. 8.

FIG. 11B is a top view of the port replicator illustrating a variation in disposition of fixing components.

FIG. 11C is a top view of the port replicator illustrating a variation in disposition of fixing components.

FIG. 11D is a top view of the port replicator illustrating a variation in disposition of fixing components.

### DETAILED DESCRIPTION

### Background of Present Disclosure

There is known a function expansion device called a port replicator that can be connected to an electronic device such as a laptop PC or a tablet PC to expand an input-output terminal, and the like. For example, in a function expansion device described in PTL 1, a plurality of types of notebook personal computers having different sizes are connected to a portable computer, and the notebook personal computer is connected to a function expansion device without changing the structure of the notebook personal computers.

A function expansion device is usually configured to be connectable to one type of electronic device, but there is also a demand for connecting a plurality of electronic devices having different sizes to one function expansion device.

For example, in a function expansion device described in PTL 1, a slide movement mechanism is slid and moved back and forth to connect laptop computers of different sizes. In a case of a configuration in which a plurality of electronic devices having different sizes can be connected by a movable component such as a slide movement mechanism as in the function expansion device described in PTL 1, there is a problem that the movable component causes a failure and durability is reduced. In addition, in a case of a device including a movable component, there is also a problem that the manufacturing cost increases.

The inventor(s) of the present invention have studied a port replicator with improved durability in a case where a plurality of electronic devices having different external sizes are attached, and have reached the following invention.

A port replicator according to a first aspect of the present disclosure is a port replicator on which an electronic device is placed, the port replicator including: a body on which the electronic device is placed; and a fixing component including a base disposed in the body and a side wall extending from the base in a direction intersecting the body and supporting an outer surface of the electronic device. The fixing component is configured to change a position of the side wall by being disposed with an orientation of the base changed.

According to such a configuration, it is possible to provide a port replicator with improved durability in a case where a plurality of computers having different external sizes are attached.

In a port replicator according to a second aspect of the present disclosure, the electronic device may include a first outer surface and a second outer surface opposed to the first outer surface, and the fixing component may include a first fixing component that is disposed along the first outer surface and supports the first outer surface, and a second fixing component that is disposed along the second outer surface and supports the second outer surface.

According to such a configuration, the electronic device can be stably supported by the two fixing components.

In a port replicator according to a third aspect of the present disclosure, the first fixing component and the second fixing component may be disposed to be opposed to each other.

According to such a configuration, the position of the electronic device on the port replicator can be easily set.

In a port replicator according to a fourth aspect of the present disclosure, the base may have a rectangular shape having a longitudinal direction and a lateral direction in plan view, and the side wall may be disposed on one end side in the lateral direction along the longitudinal direction.

According to such a configuration, the position of the side wall can be changed by changing the disposition orientation of the fixing component. Thus, when electronic devices having different sizes are connected to the port replicator, the position of the electronic devices can be easily set.

A port replicator according to a fifth aspect of the present disclosure, a recess in which the base is disposed is formed on the body, and a shape of the recess may correspond to an outer shape of the base in a plan view.

With such a configuration, it is easy set the position of the fixing component on the body.

In a port replicator according to a sixth aspect of the present disclosure, the recess may be formed in a rectangular shape in plan view.

With such a configuration, the recess can be provided according to the shape of the fixing component, and the fixing component can be easily attached.

In a port replicator according to a seventh aspect of the present disclosure, the side wall may include a plurality of walls extending in different directions.

With such a configuration, it is possible to increase variations in disposition of the side wall, and it is possible to provide a port replicator compatible with electronic devices having more different external sizes.

In a port replicator according to an eighth aspect of the present disclosure, the plurality of walls may be disposed in a polygonal shape in plan view.

With such a configuration, it is possible to increase variations in disposition of the side wall, and it is possible to provide a port replicator compatible with electronic devices having more different external sizes.

In a port replicator according to a ninth aspect of the present disclosure, the body may include a support that extends in a direction intersecting an extending direction of the side wall that supports the outer surface of the electronic device and supports the outer surface of the electronic device.

With such a configuration, the electronic device can be supported from different directions.

### First Exemplary Embodiment

### [Overall Configuration]

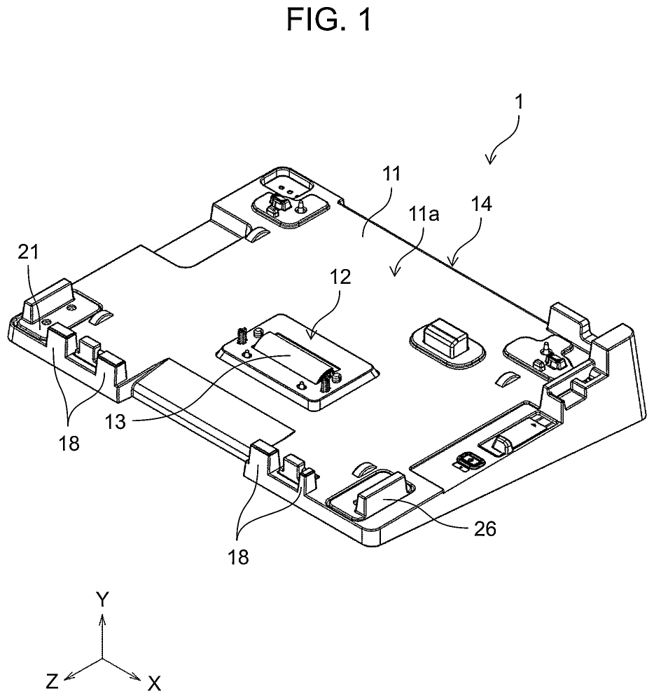

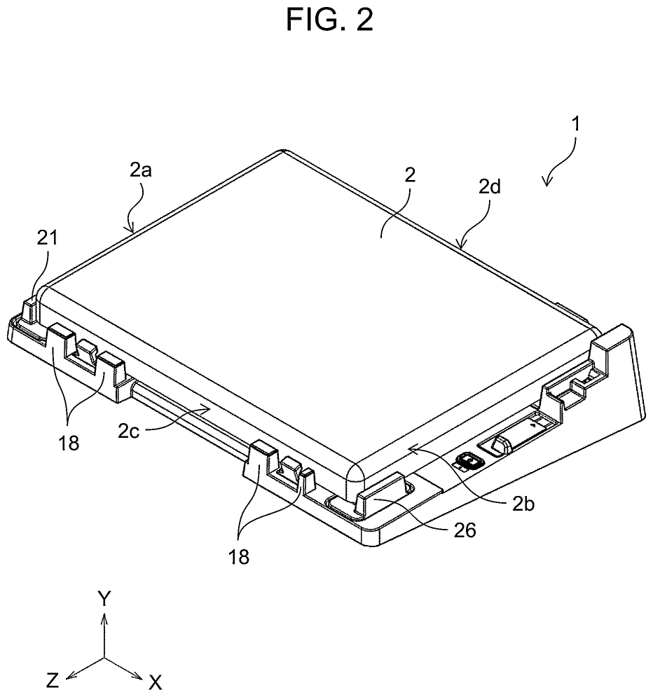

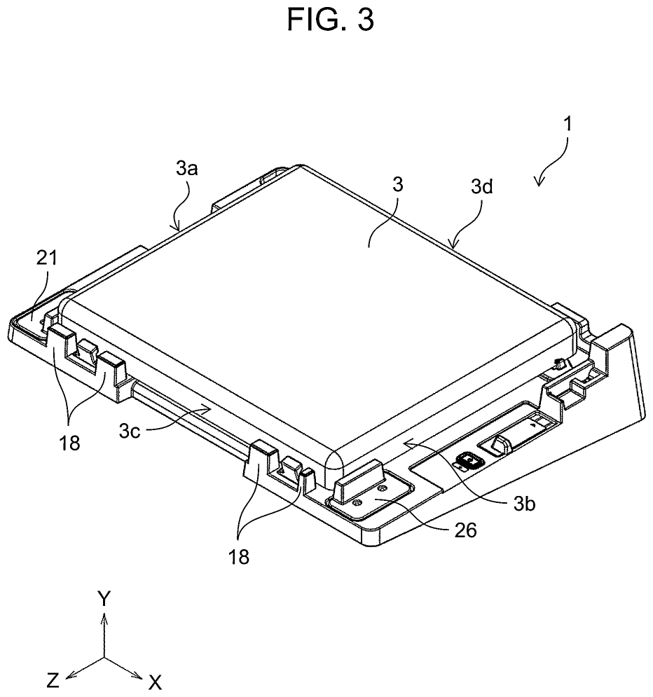

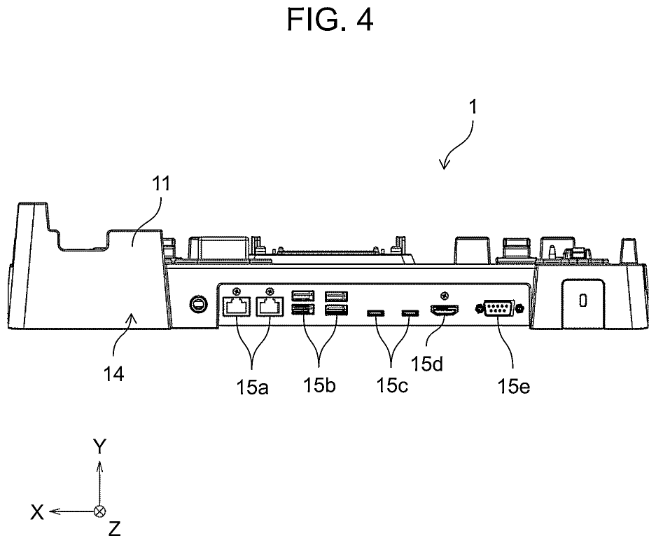

FIG. 1 is a perspective view of port replicator 1 according to a first exemplary embodiment of the present disclosure. FIG. 2 is a perspective view illustrating an example in which electronic device 2 is placed on port replicator 1 of FIG. 1. FIG. 3 is a perspective view illustrating an example in which another electronic device 3 is placed on port replicator 1 of FIG. 1. FIG. 4 is a side view of port replicator 1 of FIG. 1. Each drawing in the following description indicates an X-direction that may be referred to as a width direction, a Y-direction that may be referred to as a thickness direction, and a Z-direction that may be referred to as a depth direction.

As illustrated in FIGS. 1 to 3, port replicator 1 includes body 11 and fixing components 21, 26.

Port replicator 1 is a device that expands functions of an electronic device such as a laptop PC or a tablet PC. For example, as illustrated in FIGS. 2 and 3, when electronic device 2 or electronic device 3 is connected to port replicator 1, additional input-output ports 15a to 15e (see FIG. 4) can be used in addition to the input-output ports mounted on electronic device 2 or electronic device 3. In the present specification, connecting port replicator 1 and electronic device 2 or electronic device 3 indicates that port replicator 1 and electronic device 2 or electronic device 3 are electrically connected via connector 12 described later.

In the present exemplary embodiment, as illustrated in FIG. 2, electronic device 2 is formed in a rectangular shape in plan view. Electronic device 2 includes first outer surface 2a and second outer surface 2b opposed to first outer surface 2a. Further, third outer surface 2c connecting first outer surface 2a and second outer surface 2b and fourth outer surface 2d opposed to third outer surface 2c and connecting first outer surface 2a and second outer surface 2b are provided.

When electronic device 2 is placed on and connected to port replicator 1, first outer surface 2a and second outer surface 2b of electronic device 2 are supported by fixing components 21, 26. In other words, electronic device 2 is supported in the width direction by fixing components 21, 26. Thus, when electronic device 2 is connected to port replicator 1, electronic device 2 is fixed, and positional displacement can be prevented.

In the present exemplary embodiment, as illustrated in FIG. 3, changing the orientations of fixing components 21, 26 makes it possible to support electronic device 3 having an external size different from that of electronic device 2 in the width direction. Electronic device 3 is also formed in a rectangular shape in plan view, and has first outer surface 3a, second outer surface 3b, third outer surface 3c, and fourth outer surface 3d. Details of fixing components 21, 26 will be described later.

### <Body>

Electronic device 2 or electronic device 3 such as a laptop PC or a tablet PC is placed on body 11 of port replicator 1. In the present exemplary embodiment, body 11 has placement surface 11a for placing electronic device 2 or electronic device 3. As illustrated in FIG. 1, placement surface 11a is inclined such that the height decreases toward the front side of port replicator 1, for example. Disposing placement surface 11a in an inclined manner improves usability at the time of placing electronic device 2 or electronic device 3 on port replicator 1. The front side of port replicator 1 refers to a portion of port replicator 1 facing the +Z direction in FIG. 1.

On placement surface 11a of body 11, connector 12 for electrically connecting port replicator 1 to electronic device 2 or electronic device 3 is disposed. By connecting connector 12 to a connector provided in electronic device 2 or electronic device 3, port replicator 1 and electronic device 2 or electronic device 3 can be electrically connected. In the present exemplary embodiment, cover 13 is disposed on connector 12 to cover a terminal of connector 12. When electronic device 2 or electronic device 3 is not connected to the connector, cover 13 covers connector 12. When electronic device 2 or electronic device 3 is connected to the connector, cover 13 is open. Cover 13 is not an essential component. Body 11 can be formed of, for example, resin.

As illustrated in FIG. 4, various input-output ports are disposed on side surface 14 of body 11. The input-output port is an insertion port for a cable, a connector, or the like. In the present exemplary embodiment, for example, LAN port 15a, USB-A port 15b, USB-C port 15c, HDMI (registered trademark) port 15d, and serial port 15e are disposed on side surface 14 of port replicator 1. The type and the number of ports disposed in port replicator 1 are not limited to this, and may be more or less than the example illustrated in FIG. 4.

Two fixing components 21, 26 are disposed on body 11 of port replicator 1. Fixing components 21, 26 are used for setting the position of electronic device 2 when electronic device 2 is placed on port replicator 1, and for supporting and fixing electronic device 2 when electronic device 2 and port replicator 1 are connected. Fixing components 21, 26 will be described later.

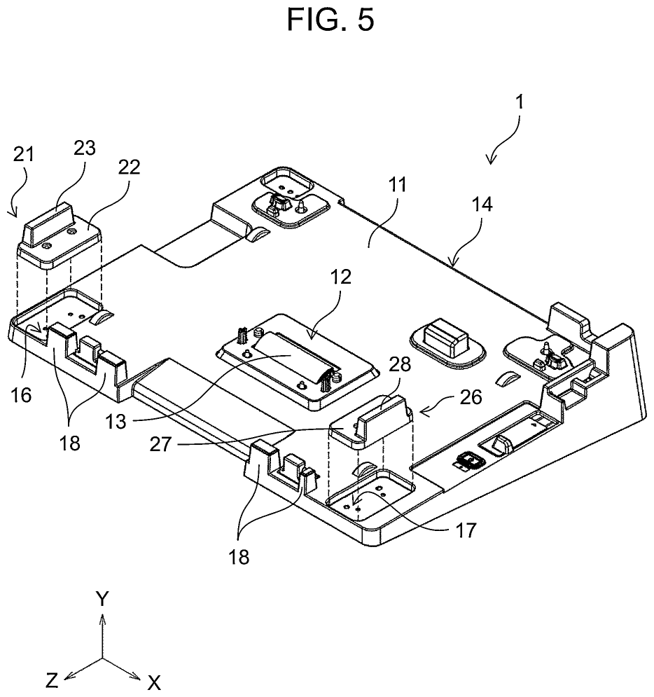

FIG. 5 is an exploded view of port replicator 1 of FIG. 1. As illustrated in FIG. 4, in the present exemplary embodiment, recesses 16, 17 for disposing bases 22, 27 of fixing components 21, 26 described later are formed in body 11. Recesses 16, 17 correspond to the outer shapes of bases 22, 27 in plan view. Specifically, in a state where bases 22, 27 are disposed in recesses 16, 17, respectively, inner walls of recesses 16, 17 are disposed along outer surfaces of bases 22, 27. In the present exemplary embodiment, as will be described later, bases 22, 27 of fixing components 21, 26 are formed in a rectangular shape, and recesses 16, 17 are formed in a rectangular shape in accordance with the shapes of bases 22, 27. Forming recesses 16, 17 in a shape along the outer walls of bases 22, 27 makes it possible to bring the inner walls of recesses 16, 17 into contact with the outer surfaces of bases 22, 27 to set the positions of bases 22, 27.

Body 11 further includes support 18 that supports third outer surface 2c of electronic device 2 or third outer surface 3c of electronic device 3. When electronic device 2 or electronic device 3 is placed on body 11, the position of electronic device 2 or electronic device 3 can be set by supporting electronic device 2 or electronic device 3 from the width direction and the depth direction by fixing components 21, 26 and support 18. Support 18 is not an essential component.

### <Fixing Component>

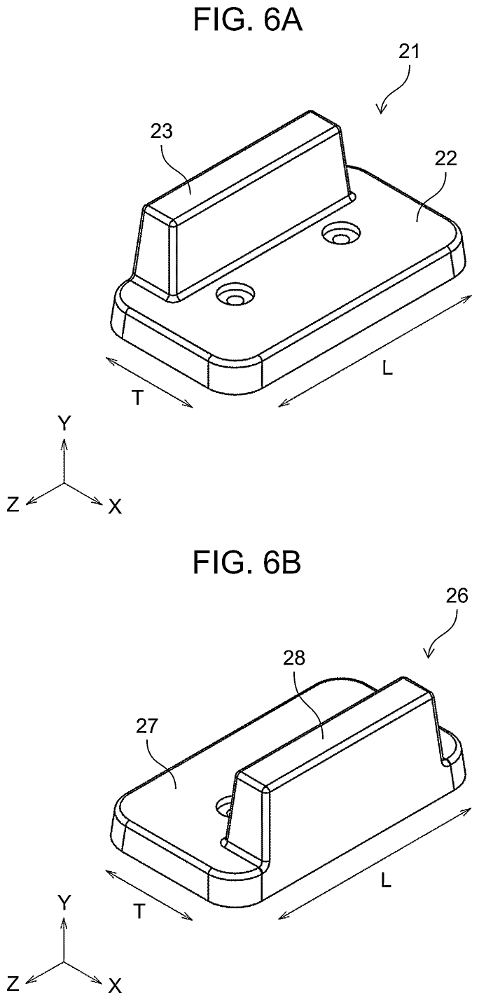

FIGS. 6A and 6B are perspective views illustrating fixing components 21, 26. As illustrated in FIGS. 6A and 6B, fixing components 21, 26 have bases 22, 27 and side walls 23, 28, respectively. Fixing components 21, 26 are formed of, for example, resin. As the resin used for fixing components 21, 26, for example, a resin having a low friction coefficient such as polyacetal (POM) may be used. Using a resin having a low friction coefficient makes it possible to prevent damage, deformation, or the like of fixing components 21, 26 due to friction generated when electronic device 2 or electronic device 3 is placed on port replicator 1.

In the present exemplary embodiment, fixing components 21, 26 include first fixing component 21 that supports first outer surface 2a of electronic device 2 and second fixing component 26 that supports second outer surface 2b. Disposing fixing components 21, 26 with their orientations changed allows first fixing component 21 to support first outer surface 3a of electronic device 3 and second fixing component 26 to support second outer surface 3b of electronic device 3.

Bases 22, 27 of fixing components 21, 26 are disposed in body 11. In the present exemplary embodiment, as described above, bases 22, 27 are disposed in recesses 16, 17 provided in body 11. In the present exemplary embodiment, each of bases 22, 27 has a rectangular shape having longitudinal direction L and lateral direction T in plan view. Since recesses 16, 17 of body 11 are formed in accordance with the shapes of bases 22, 27, the positions of bases 22, 27 can be set by fitting bases 22, 27 into recesses 16, 17. Bases 22, 27 can be fixed to body 11 by, for example, vis screws or screws. Alternatively, for example, base 22 may be fixed to body 11 using a structure such as snap fit in which a hook provided in base 22 is fitted into a fitting recess or a fitting hole provided in body 11.

Side walls 23, 28 extend from bases 22, 27 in a direction intersecting body 11 (Y-direction in FIG. 5), and support outer surfaces 2a, 2b (see FIG. 2) of electronic device 2. By changing the orientations of fixing components 21, 26, the positions of side walls 23, 28 are changed, and side walls 23, 28 support outer surfaces 3a, 3b (see FIG. 3) of electronic device 3.

Side walls 23, 28 are preferably formed to have a thickness of, for example, about 10 mm. Forming the side walls with a thickness of about 10 mm can prevent deformation or breakage of fixing components 21, 26.

In the present exemplary embodiment, side walls 23, 28 are disposed along longitudinal direction L of bases 22, 27. Further, side walls 23, 28 are disposed at one end in lateral direction T of bases 22, 27. Since side walls 23, 28 are disposed at one end in lateral direction T, the positions of side walls 23, 28 can be changed when bases 22, 27 are disposed with their orientations changed.

In the present exemplary embodiment, fixing components 21, 26 have the same shape, but are disposed in different orientations. Specifically, fixing component 21 is disposed in an orientation rotated by 180 degrees about the thickness direction with respect to fixing component 26.

Fixing components 21, 26 are configured such that the positions of side walls 23, 28 in the width direction can be changed by disposing bases 22, 27 with their orientations changed. In the present exemplary embodiment, side walls 23, 28 extend in the Z direction, and the positions of side walls 23, 28 can be moved in the X direction by changing the orientations of bases 22, 27. By moving the positions of side walls 23, 28 like this, electronic device 2 and electronic device 3 having different external sizes can be supported by same fixing components 21, 26.

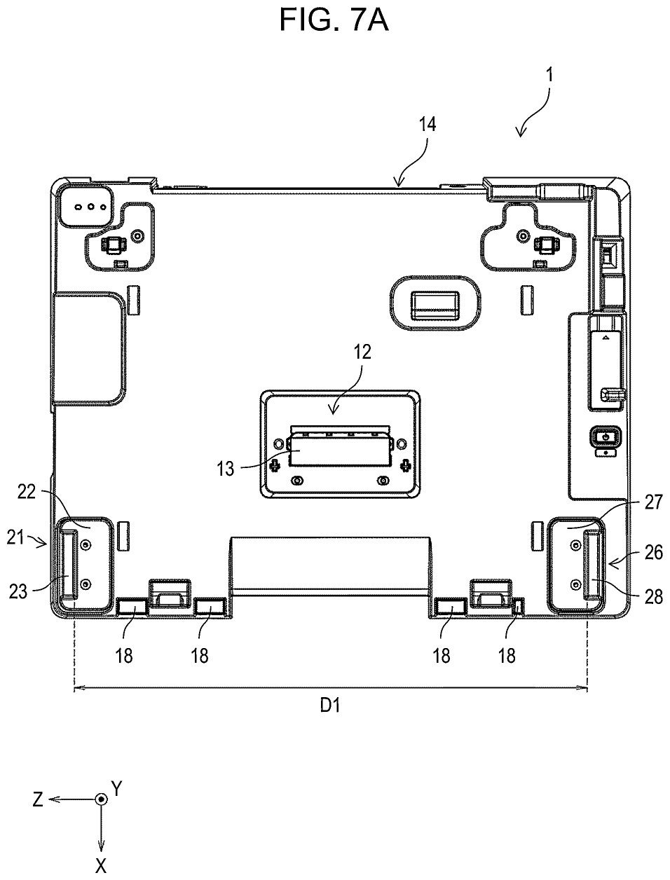

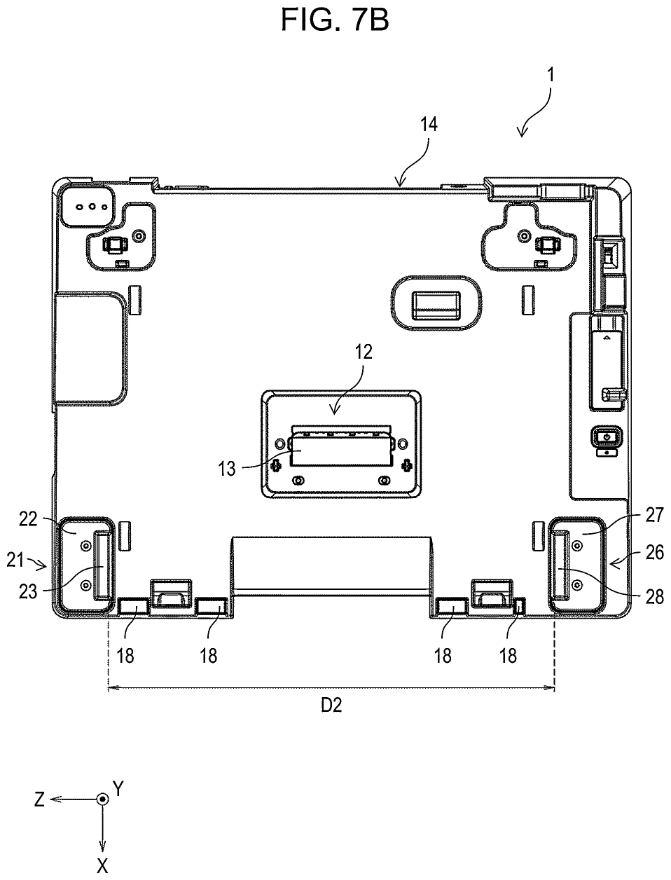

FIG. 7A is a top view of port replicator 1 of FIG. 1. FIG. 7B is a top view of port replicator 1 in a state where the disposition of fixing components 21, 26 is changed. In the present exemplary embodiment, as illustrated in FIGS. 7A and 7B, first fixing component 21 and second fixing component 26 are disposed to be opposed to each other. Disposing fixing components 21, 26 in this manner makes it possible to support electronic device 2 or electronic device 3 in the width direction, and fix and position the electronic device.

In port replicator 1 illustrated in FIG. 7A, fixing components 21, 26 are disposed so as to place electronic device 2 illustrated in FIG. 2. Specifically, distance DI between side wall 23 and side wall 28 is set such that side wall 23 of first fixing component 21 and side wall 28 of second fixing component 26 can sandwich and support electronic device 2 in the width direction.

In port replicator 1 illustrated in FIG. 7B, fixing components 21, 26 are disposed so as to place electronic device 3 illustrated in FIG. 3. Fixing components 21, 26 are rotated by 180 degrees about the thickness direction from the state illustrated in FIG. 7A and disposed on body 11. Since side walls 23, 28 are disposed on one end side in lateral direction T (see FIGS. 6A and 6B) of bases 22, 27, when the side walls are rotated by 180 degrees about the thickness direction, the positions of side walls 23, 28 move along the width direction. As a result, as illustrated in FIG. 7B, distance D2 between side wall 23 of first fixing component 21 and side wall 28 of second fixing component 26 becomes smaller than distance D1. Thus, two electronic device 2 and electronic device 3 having different external sizes can be fixed and positioned using same fixing components 21, 26. That is, for first fixing component 21 and second fixing component 26, distance D1 between side wall 23 and side wall 28 can be changed to distance D2 by disposing bases 22, 27 with their orientations changed.

### [Effects]

According to the above-described exemplary embodiment, it is possible to provide a port replicator with improved durability in a case where a plurality of electronic devices having different external sizes are attached. After the electronic device is connected to port replicator 1, the electronic device is preferably fixed to port replicator 1 so that the electrical connection between port replicator 1 and the electronic device is not disconnected. In port replicator 1, electronic device 2 and electronic device 3 having different external sizes can be fixed by changing the disposition orientations of fixing components 21, 26. Disposing fixing components 21, 26 with their orientations changed makes it possible to reduce the number of movable components that are likely to cause failure and to improve durability. Further, fixing components 21, 26 can be easily attached to body 11 by vis screws or screws, snap-fit, or the like.

In the above-described exemplary embodiment, an example in which port replicator 1 includes two fixing components 21, 26 has been described, but the present invention is not limited to this configuration. The number of the fixing components may be one or three or more.

In the above-described exemplary embodiment, an example in which first fixing component 21 and second fixing component 26 are disposed to be opposed to each other has been described, but the present invention is not limited to this configuration. For example, first fixing component 21 and second fixing component 26 may be disposed diagonally to electronic device 2 or electronic device 3.

In the above-described exemplary embodiment, an example in which bases 22, 27 of fixing components 21, 26 are formed in a rectangular shape in plan view has been described, but the present invention is not limited to this configuration. Bases 22, 27 may be formed in, for example, a polygonal shape or a circular shape in plan view.

In the above-described exemplary embodiment, an example in which recesses 16, 17 for disposing bases 22, 27 of fixing components 21, 26 are formed in body 11 has been described, but the present invention is not limited to this configuration. The recesses do not have to be formed in body 11.

In the above-described exemplary embodiment, an example in which recesses 16, 17 are formed in a rectangular shape in plan view has been described, but the present invention is not limited to this configuration. Recesses 16, 17 only need to have shapes corresponding to the shapes of bases 22, 27, and they may be formed in, for example, a polygonal shape or a circular shape in plan view.

In the above-described exemplary embodiment, an example in which fixing components 21, 26 have the same shape has been described, but the present invention is not limited to this configuration. The shapes of fixing components 21, 26 may be different from each other.

### Second Exemplary Embodiment

A port replicator according to a second exemplary embodiment of the present invention will be described. The second exemplary embodiment will be described mainly on the points different from the first exemplary embodiment. In the second exemplary embodiment, components identical or equivalent to those in the first exemplary embodiment are denoted with the same reference marks as those in the first exemplary embodiment. In addition, the description already given for the first exemplary embodiment will be omitted for the second exemplary embodiment.

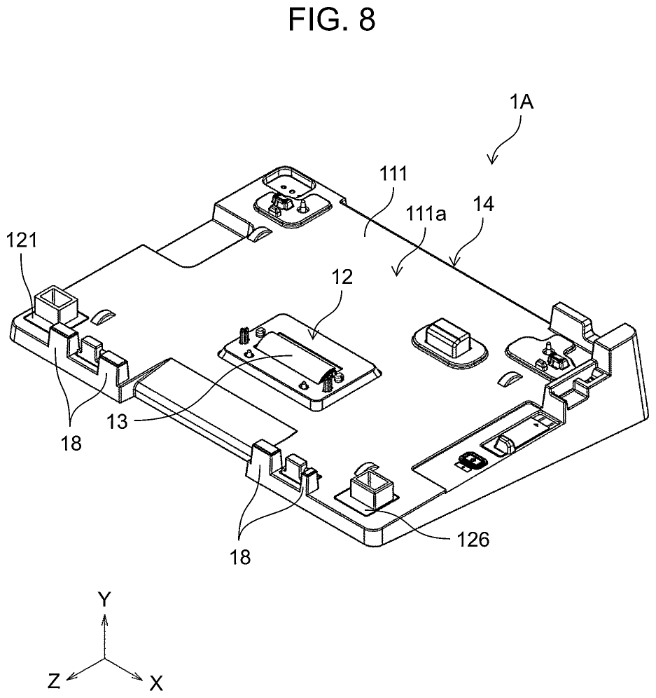

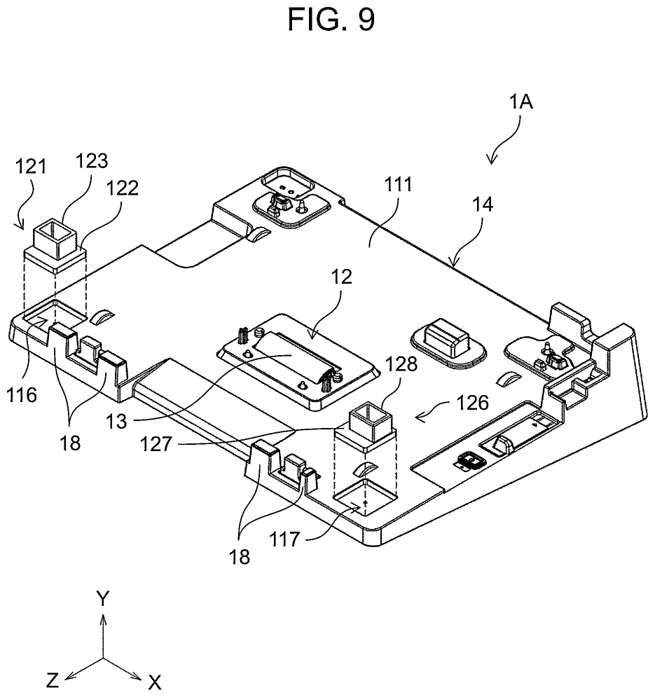

FIG. 8 is a perspective view of port replicator 1A according to the second exemplary embodiment of the present disclosure. FIG. 9 is an exploded perspective view of port replicator 1A of FIG. 8. As illustrated in FIGS. 8 and 9, the second exemplary embodiment is different from the first exemplary embodiment in shapes of fixing components 121, 126 and shapes of recesses 116, 117 formed in body 111.

In the present exemplary embodiment, bases 122, 127 of fixing components 121, 126 are formed in a square shape in plan view. Thus, recesses 116, 117 formed in body 111 are also formed in a square shape in plan view.

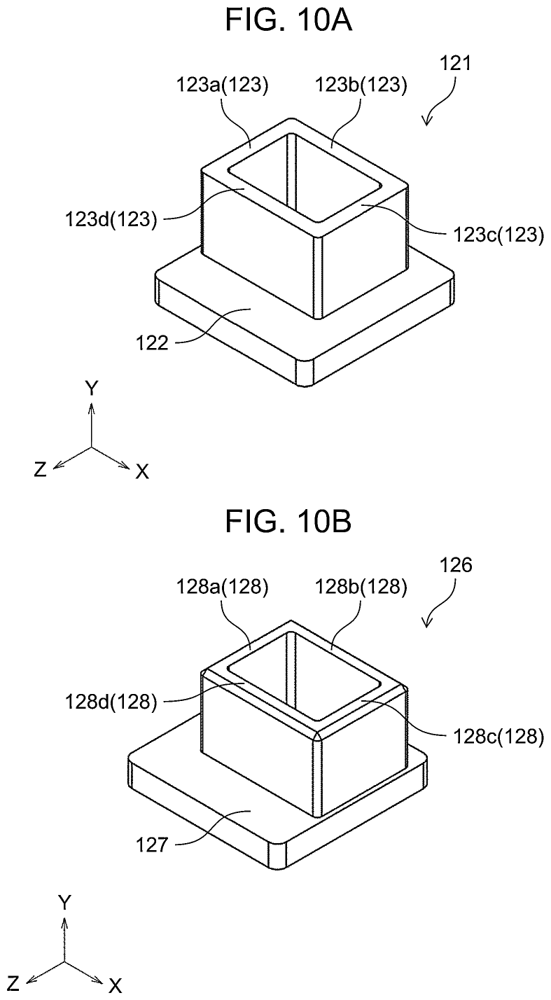

FIGS. 10A and 10B are perspective views illustrating fixing components 121, 126. As illustrated in FIG. 10A, side wall 123 of fixing component 121 includes four walls 123a to 123d extending in different directions. Walls 123a to 123d are disposed in a rectangular shape in plan view. Similarly, as illustrated in FIG. 10B, side wall 128 of fixing component 126 includes four walls 128a to 128d extending in different directions. Walls 128a to 128d are disposed in a quadrangular shape in plan view. In the present exemplary embodiment, as illustrated in FIGS. 10A and 10B, fixing component 121 and fixing component 126 do not have the same shape but have line-symmetric shapes.

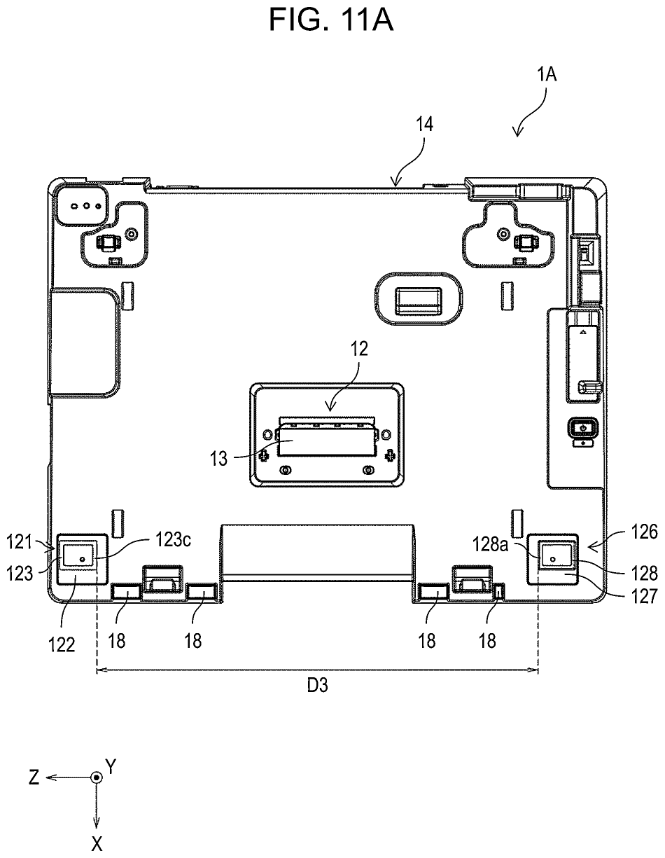

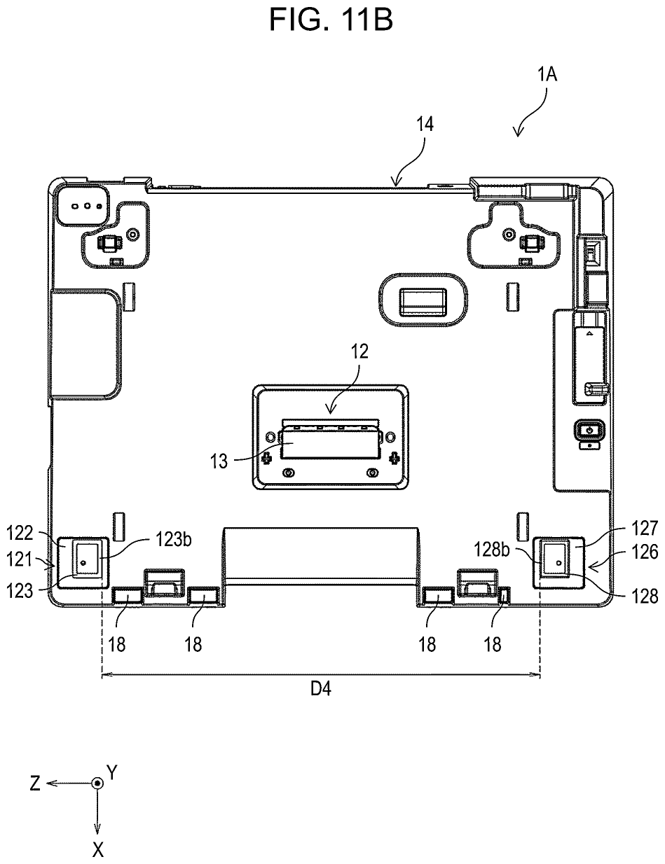

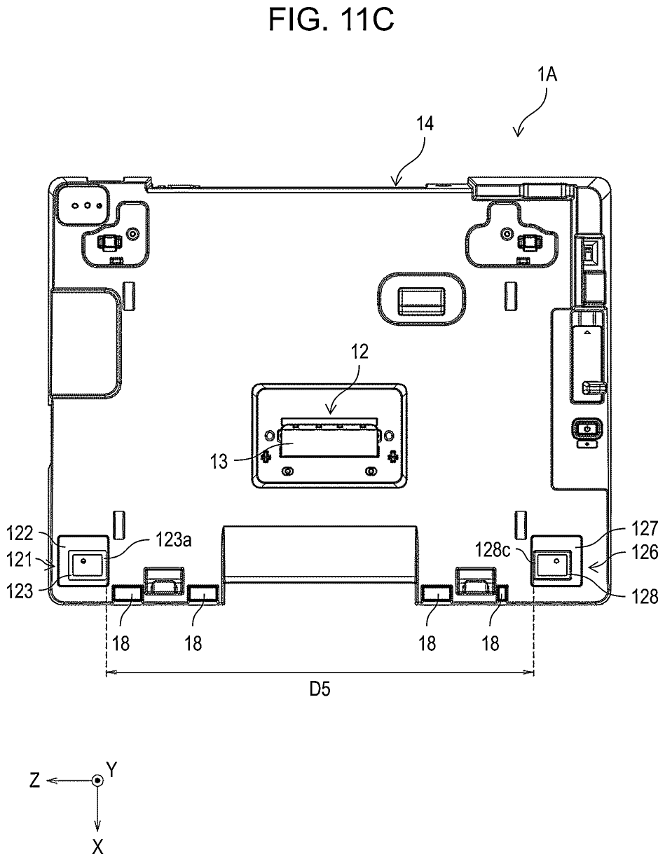

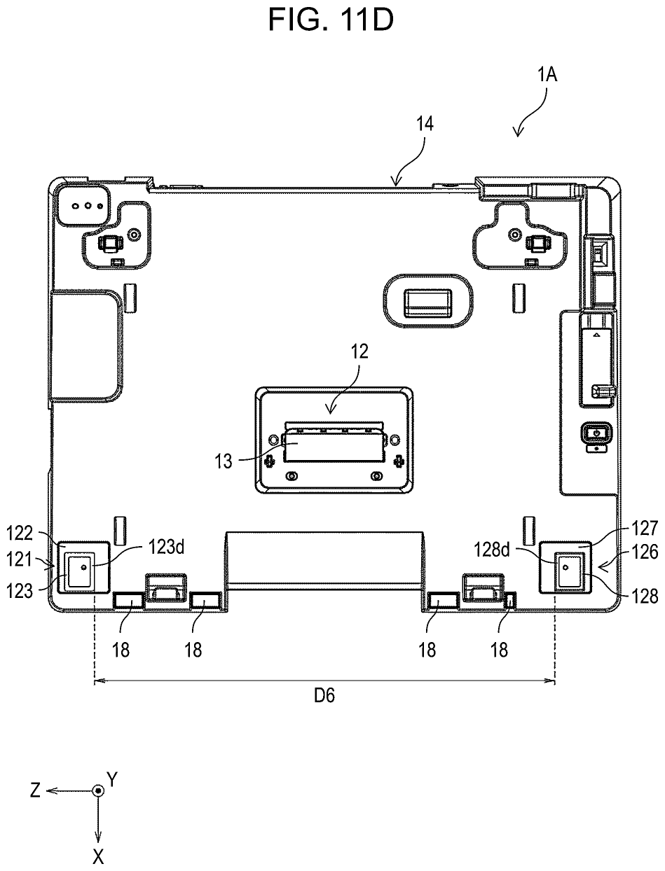

FIG. 11A is a top view of port replicator 1A of FIG. 8. In the state of FIG. 11A, the electronic device can be supported in the width direction by wall 123c of fixing component 121 and wall 128a of fixing component 126. At this time, wall 123c and wall 128a are disposed away from each other by distance D3. Thus, an electronic device having a width corresponding to distance D3 can be fixed and positioned.

FIGS. 11B to 11D are top views of port replicator 1A illustrating variations in the disposition of fixing components 121, 126.

In the example of FIG. 11B, fixing component 121 is rotated by +90 degrees about the thickness direction from the disposition of FIG. 11A and disposed, and fixing component 126 is rotated by −90 degrees about the thickness direction from the disposition of FIG. 11A and disposed. Note that +90 degrees means to rotate clockwise by 90 degrees about the Y axis, and −90 degrees means to rotate counterclockwise by 90 degrees about the Y axis. In this case, an electronic device can be supported in the width direction by wall 123b of fixing component 121 and wall 128b of fixing component 126. At this time, wall 123b and wall 128b are disposed away from each other by distance D4. Thus, an electronic device having a width corresponding to distance D4 can be fixed and positioned.

In the example of FIG. 11C, fixing component 121 is rotated by +180 degrees about the thickness direction from the disposition of FIG. 11A and disposed, and fixing component 126 is rotated by −180 degrees about the thickness direction from the disposition of FIG. 11A and disposed. In this case, an electronic device can be supported in the width direction by wall 123a of fixing component 121 and wall 128c of fixing component 126. At this time, wall 123a and wall 128c are disposed away from each other by distance D5. Thus, an electronic device having a width corresponding to distance D5 can be fixed and positioned.

In the example of FIG. 11D, fixing component 121 is rotated by +270 degrees about the thickness direction from the disposition of FIG. 11A and disposed, and fixing component 126 is rotated by −270 degrees about the thickness direction from the disposition of FIG. 11A and disposed. In this case, an electronic device can be supported in the width direction by wall 123d of fixing component 121 and wall 128d of fixing component 126. At this time, wall 123d and side 128d are disposed away from each other by distance D6. Thus, an electronic device having a width corresponding to distance D6 can be fixed and positioned.

Above-described distances D3 to D6 all have different sizes. Thus, in the present exemplary embodiment, electronic devices of four types of external sizes can be supported in the width direction, fixed, and positioned.

According to the above-described exemplary embodiment, it is possible to fix and position more types of electronic devices while improving durability.

In the exemplary embodiment described above, an example in which side walls 123, 128 of fixing components 121, 126 respectively include four walls 123a to 123d and 128a to 128d has been described, but the present invention is not limited to this configuration. Side walls 123, 128 may cach include two or more walls.

In the above-described exemplary embodiment, an example in which bases 122, 127 of fixing components 121, 126 are each formed in a square shape in plan view has been described, but the present invention is not limited to this configuration. Bases 122, 127 may have a polygonal shape other than a square shape. In this case, the shapes of recesses 116, 117 formed in body 111 are also formed in polygonal shapes in accordance with the shapes of bases 122, 127. For example, when bases 122, 127 and recesses 116, 117 are formed in a regular polygon, they have rotational symmetry, and thus the disposition of bases 122, 127 can be easily changed. Further, bases 122, 127 and recesses 116, 117 may be formed in a circular shape in plan view.

The present disclosure can be widely applied to a port replicator to which an electronic device can be connected.

What is claimed is:

1. A port replicator on which an electronic device is placed, the port replicator comprising:
a body on which the electronic device is placed; and
a fixing component including a base disposed in the body and a side wall extending from the base in a direction intersecting the body and supporting an outer surface of the electronic device,
wherein the fixing component is configured to change a position of the side wall by being disposed with an orientation of the base changed.

2. The port replicator according to claim 1, wherein
the outer surface of the electronic device includes a first outer surface and a second outer surface opposed to the first outer surface, and
the fixing component includes a first fixing component that is disposed along the first outer surface and supports the first outer surface, and a second fixing component that is disposed along the second outer surface and supports the second outer surface.

3. The port replicator according to claim 2, wherein the first fixing component is opposed to the second fixing component.

4. The port replicator according to claim 1, wherein
the base has a rectangular shape having a longitudinal direction and a lateral direction in plan view, and
the side wall is disposed on one end side in the lateral direction along the longitudinal direction.

5. The port replicator according to claim 1, wherein
the body includes a recess in which the base is disposed, and
a shape of the recess corresponds to an outer shape of the base in a plan view.

6. The port replicator according to claim 5, wherein the recess has a rectangular shape in plan view.

7. The port replicator according to claim 1, wherein the side wall includes a plurality of walls extending in different directions.

8. The port replicator according to claim 7, wherein the plurality of walls are disposed in a polygonal shape in plan view.

9. The port replicator according to claim 8, wherein
the plurality of walls are four walls, and
the four walls are disposed in a quadrangular shape in plan view.

10. The port replicator according to claim 1, wherein the body includes a support that extends in a direction intersecting an extending direction of the side wall that supports the outer surface of the electronic device and supports the outer surface of the electronic device.

11. The port replicator according to claim 3, wherein
the first fixing component includes a first base disposed in the body and a first side wall extending from the first base and supporting the first outer surface,
the second fixing component includes a second base disposed in the body and a second side wall extending from the second base and supporting the second outer surface, and
the fixing component is configured to change a distance between the first side wall and the second side wall by being disposed with orientations of the first base and the second base changed.
